(19) United States
(12) Patent Application Publication
(10) Pub. No.: US 2019/0148942 A1
(43) Pub. Date: May 16, 2019

(54) SYSTEM FOR INTEGRATING AUTOMATIC GENERATION CONTROL WITH GENERATION SCHEDULING FOR REGULATION OF POWER GENERATION

(71) Applicant: King Fahd University of Petroleum and Minerals, Dhahran (SA)

(72) Inventor: Ali T. AL-AWAMI, Dhahran (SA)

(73) Assignee: King Fahd University of Petroleum and Minerals, Dhahran (SA)

(21) Appl. No.: 16/115,045

(22) Filed: Aug. 28, 2018

Related U.S. Application Data
(60) Provisional application No. 62/585,270, filed on Nov. 13, 2017.

(51) Int. Cl. H02J 3/24; H02J 3/16

(52) U.S. Cl. CPC H02J 3/24; H02J 2003/002; H02J 3/16

(57) ABSTRACT

The present disclosure relates to an integration of automatic generation control and economic dispatch to achieve real-time optimization for power grid operation. Specifically, the present disclosure combines the above such that automatic generation control serves as an inner control loop and feedback-control-based economic dispatch serves as an outer loop. Moreover, a system equivalent generator and load are employed to represent a total system load.

### CROSS-REFERENCE TO RELATED APPLICATIONS

The present application claims priority to U.S. Provisional Application No. 62/585,270, filed Nov. 13, 2017, which is hereby incorporated by reference in its entirety for all purposes.

### BACKGROUND

### Field of the Disclosure

The present disclosure relates to a real-time operational framework for electric grids combining automatic generation control and economic dispatch via control-based generation scheduling.

### Description of the Related Art

With respect to power generation, there is a direct correlation between demand, or load, changes and system frequency. When generated power, or electricity supply, is higher than actual demand, the frequency of the system increases, and vice versa. However, these frequency changes must be maintained within acceptable limits in order to avert instability within the system. Ideally, system frequency is maintained at a nominal value irrespective of changes in system load, reflecting a balance between power generation and demand.

A recent shift to renewable energy sources, in light of the potential environmental impact of fossil fuel consumption, has refocused attention on maintaining and controlling power generation in the context of power demand. The variable nature and dependability of renewable energy generation, however, with the potential to shift dramatically by the second, has brought light to the inefficiencies of current control schemes for power generation. A control scheme allowing for control of power generation in real-time has yet to be developed.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a system and method for regulating power generation.

According to an embodiment, the present disclosure is related to a method for regulating power generation, comprising receiving, via processing circuitry, initial net load power data from an electric power system, determining, via the processing circuitry, one or more power generation set-points of one or more power generation units based upon the initial net load power data, transmitting, via the processing circuitry, each of the one or more power generation set-points to a corresponding at least one power generation unit of the one or more power generation units, measuring, via the processing circuitry, a frequency deviation of each of the one or more power generation units, and updating, via the processing circuitry, the one or more power generation set-points of the one or more power generation units, wherein updating the one or more power generation set-points of the one or more power generation units is based upon the measured frequency deviation of each of the one or more power generation units.

According to an embodiment, the present disclosure further relates to a system for regulating power generation of an electric power system, comprising one or more power generation units, and a control device having a processing circuitry configured to receive initial net load power data from the electric power system, determine one or more power generation set-points of at least one of the one or more power generation units based upon the initial net load power data, transmit each of the one or more power generation set-points to a corresponding at least one power generation unit of the one or more power generation units, measure a frequency deviation of each of the one or more power generation units, and update the one or more power generation set-points of the one or more power generation units, wherein updating the one or more power generation set-points of the one or more power generation units is based upon the measured frequency deviation of each of the one or more power generation units.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of an exemplary automatic generation control scheme, according to an embodiment of the present disclosure;

FIG. 2 is a schematic of an exemplary automatic generation control scheme;

FIG. 3 is a schematic of an automatic generation control scheme, according to an exemplary embodiment of the present disclosure;

FIG. 4 is a schematic of an exemplary control scheme integrating economic dispatch and automatic generation control schemes, according to an embodiment of the present disclosure;

FIG. 5 is a graphical representation of a response of an integrated control scheme in response to a step increase in net load, according to an embodiment of the present disclosure;

FIG. 6 is a graphical representation of a response of an integrated control scheme in response to a step increase in net load, according to an embodiment of the present disclosure;

FIG. 7 is a graphical representation of a response of an integrated control scheme in response to random changes in net load, according to an embodiment of the present disclosure;

FIG. 8 is a graphical representation of a response of an integrated control scheme in response to random changes in net load, according to an embodiment of the present disclosure;

FIG. 9 is a flowchart describing an implementation of a control device configured to execute an integrated control scheme, according to an embodiment of the present disclosure; and

FIG. 10 is a description of hardware of a control device configured to execute an integrated control scheme, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Conventional electricity generation is based on fossil fuels such as oil, gas, and coal. Due to recently increased concerns regarding the environmental impact of carbon emissions produced during the usage of such fossil fuels, policy makers and researchers, alike, have turned to renewable energy sources to power the future. Of these renewable energy sources, solar and wind power, as a result of their technical and economic feasibility, have emerged as leading technologies. The variable nature of these renewable energy sources, however, limits their implementation, especially at increased penetration levels where large-scale integration into an electric power grid may degrade the overall grid's power quality and reliability.

Because of the above-described fluctuations in renewable energy sources, automatic generation control scheduling, a secondary control mechanism responsible for maintaining system frequency at a nominal value, thereby balancing generation and load, is challenged. Specifically, this is due to the relationship between load changes and system frequency. When electricity supply is higher than actual demand, system frequency increases, and vice versa. Frequency deviations, however, in context of nominal values, must be kept within acceptable limits in order to avert instability in the system. In other words, generation and demand must be balanced at all times.

In the case of a single generator within a multi-generator network, a generation-load balancing action of a governor, a primary control, may result in unacceptable frequency deviations, as the generator's droop characteristic prevents hunting within the multi-generator network. For example, in response to a sudden decrease in load, and therefore, an increase in frequency, or turbine speed, a governor may decrease generation in order to match the reduced load. While it may be possible, therefore to match generation and load, it is not guaranteed that the frequency of the system will return to a reference set point, a result of the droop characteristics of the generator. To this end, and as alluded to above, automatic generation control (AGC), a secondary control, is the control mechanism responsible for maintaining system frequency of the multi-generator network at its nominal value. Specifically, AGC decomposes the multi-generator network into ‘balancing authorities’, each ‘balancing authority’ generating an area control error (ACE) signal that provides input to a proportional-integral controller in order to adjust governor set-points at participating generators.

Both primary and secondary control levers use local control signals such that changes in frequency and load trigger proper valve and set-point changer machine actions, respectively. From a high-level, as it relates to a single generator within a multi-generator network, the governor, or primary control, balances generation and demand around a load reference set-point while the AGC, or secondary control, updates the load reference set-point in order to maintain a nominal system frequency value. Moreover, in the case of the multi-generation unit facility, a centralized generation scheduling program may apportion load to each of multiple generating units in order to facilitate the governor and AGC functions to run the system in the most efficient manner. According to an embodiment, the centralized generation scheduling program may be, but is not limited to, an economic dispatch (ED) program. Typically, optimal generation schedules via ED are updated every 5-10 minutes, or hourly, while AGC produces raise/lower generation signals once every 2-4 seconds between ED scheduling.

As a result, the relationship between these hierarchical and discretized temporal implementations of the AGC, ED, and the continuously changing nature of demand leads to suboptimal operation. This is due, in part, to the dependence of AGC on ED signals for optimal operation. ED, however, is often slow to respond to rapid changes in load. Hence, between ED evaluations of the system of generators, in a classical approach, AGC often turns to participation factors and other ad-hoc techniques to adjust generators' set points.

Moreover, though broadly accepted, the above-described conventional control scheme fails when applied to operation of modern power grids with high penetration of renewable energy sources. To this end, several schemes have been proposed to improve the economics of the load-frequency control scheme, including those aimed at improving the operation of the classical AGC, while others, the classical ED program, independently.

According to an embodiment, the present disclosure describes an integrated real-time framework for ED and AGC in a feedback control scheme. The ED generation scheduler may be configured to distribute optimal base points to all generators in real-time and the AGC may be configured to move each generator around its base point to maintain frequency within acceptable limits. In other words, the present disclosure describes an integrated control scheme that may comprise AGC, as an inner control loop, whose set points are driven by a slower, outer loop of ED. This framework may, ultimately, serve as a catalyst for integrating large capacities of renewable energy sources while minimizing negative effects on power system stability and operation.

### Generation-Load Balance

Following changes in electricity demands, resulting in fluctuations in net load, or the difference between demand and generation, defined as ΔPₑ, a primary control, or governor, may respond. By measuring frequency deviations, or speed deviations, defined as Δω, appropriate changes in valve actuating signals, ΔPᵥ, may be sent to a turbine. Changes in ΔPᵥ result in changes in mechanical power, ΔPₘ, of a turbine-generator shaft until a generation-load balance is achieved. When a single generator within a multi-generator system is considered, following action of the primary control, frequency deviation of the multi-generator system may be non-zero, due to the droop characteristics of a governor, or primary control. In an embodiment, droop characteristics define the primary frequency control stage at which a generator's desired power output is moved above or below its base point proportional to a magnitude of frequency deviation. Models of a generator, electrical load, turbine, and governor, in the context of small perturbations in frequency-domain, are given in (1) to (4), respectively,

$$\begin{matrix}Δ ω ( s ) = \frac{1}{2 Hs} [ Δ {P}_{m} ( s ) - Δ {P}_{e} ( s ) ] & ( 1 ) \\ Δ {P}_{e} ( s ) = Δ {P}_{L} ( s ) + D Δω ( s ) & ( 2 ) \\ Δ {P}_{m} ( s ) = \frac{1}{1 + {τ}_{t} s} Δ {P}_{v} ( s ) & ( 3 ) \\ Δ {P}_{v} ( s ) = \frac{1}{1 + {τ}_{g} s} Δ {P}_{g} ( s ) & ( 4 ) \\ Δ {P}_{g} ( s ) = Δ {P}_{ref} ( s ) - \frac{1}{R} Δ ω & ( 5 )\end{matrix}$$

where H is the angular momentum, or generator damping, of a machine, τₜ is a time-constant of the turbine, τ_{g} is a time-constant of the governor, and D, in KW/Hz, is a sensitivity of load to changes in frequency.

In (2), the first and second terms on the right hand side of the equation are non-frequency and frequency sensitive loads, respectively. The input to the governor is given in (5), where the change in load or speed reference set-point is ΔP_{ref} and R is the regulation of the governor (or droop characteristic). This control loop, where ΔP_{ref} is zero, is referred to as the primary control loop.

In order to maintain zero system frequency deviations, however, the generator's desired power output may be further driven by a secondary control action. This secondary control action, or AGC, comprising an integral controller, may vary the load reference set-point of each generator in order to ensure zero steady-state error in system frequency.

### Automatic Generation Control Modeling

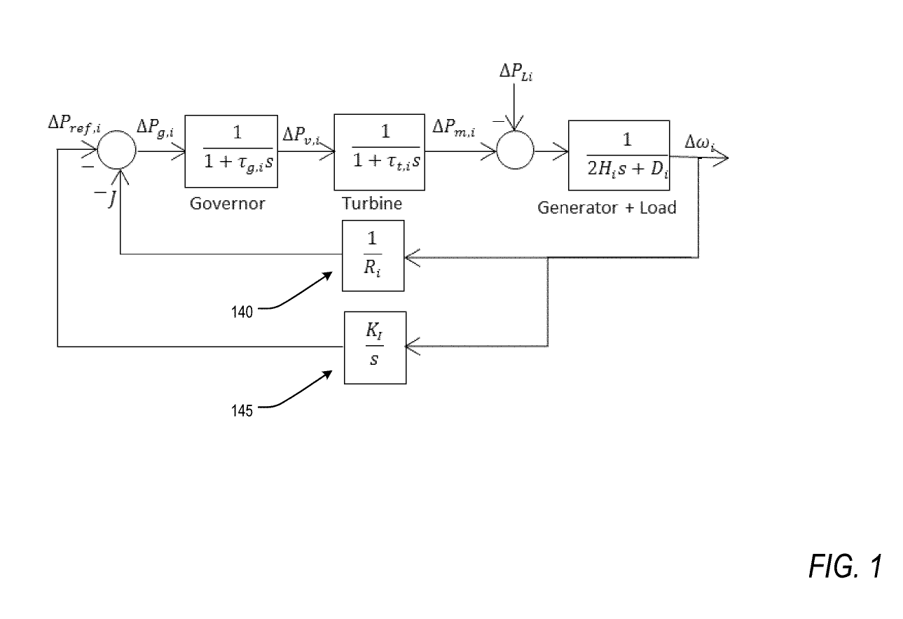

As alluded to, AGC helps to reset the governor to produce a desired power output at a nominal frequency by shifting the load reference set-point. It comprises an integrator and a gain where the input is Δω. According to an exemplary embodiment, a closed-loop diagram of the primary control 140 and secondary, AGC control 145 is shown in FIG. 1. Specifically, FIG. 1 is a schematic of an AGC model implemented, as a secondary control, within an isolated system with a single generating unit.

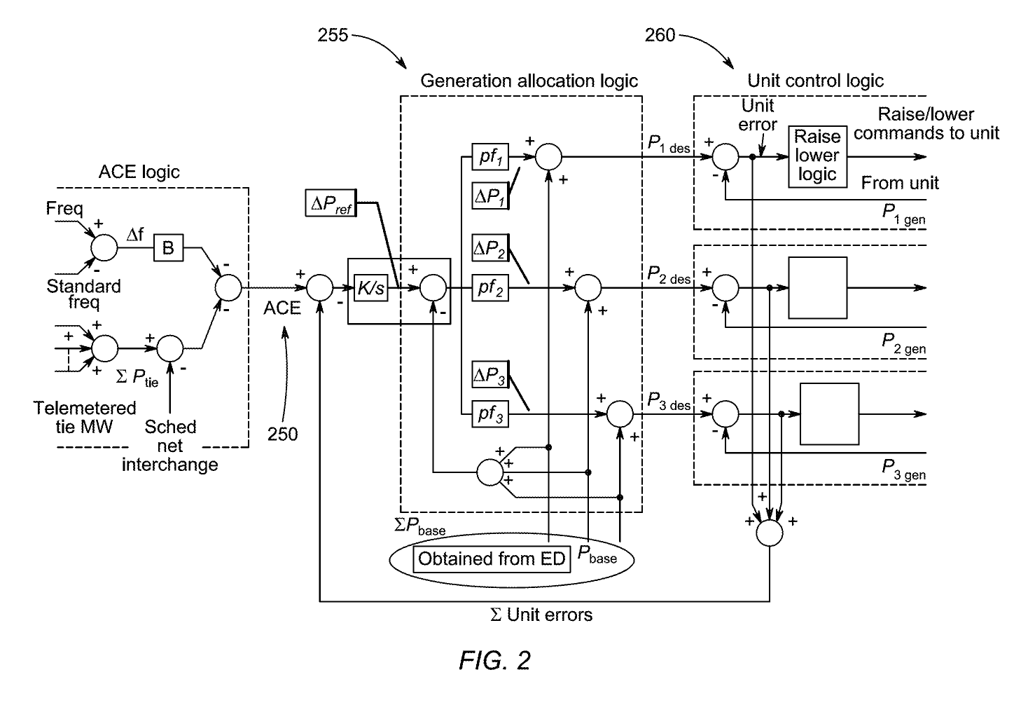

While efficient within a single generator system, in a multi-generator facility, AGC and the primary control, or governor, are not capable of guaranteeing efficiency of all units in the context of system load. To this end, FIG. 2 is a schematic of an exemplary AGC model expanded to a system of multiple generator units, where each generator may have its own primary control loop, characterized by its own regulation gain, R. In the exemplary model, AGC employs an ACE signal 250, including telemetered-tie MW and scheduled net interchange, to evaluate error within system balancing authorities comprising subunits of multiple generators. In an isolated multiple generator system, the telemetered and scheduled net-interchange powers may be set to zero. In the case of multiple generators. Further, AGC may utilize ED generation base points 255 (P_{base}) as inputs. Then, based on a system frequency deviation, AGC may determine a total required generation adjustment (ΔP_{ref}), or regulation signal, in an effort to adjust set-points of participating generators 260 and minimize the ACE signal. Classically, in order to determine the total required generation adjustment of a generator i, participation factors may be deployed, wherein

ΔPᵢ=pfᵢ·ΔP_{ref},Σᵢpfᵢ=1 (6)

### Economic Dispatch Modeling

Complementary to AGC, a classical formulation for ED in an isolated, multiple generator system is described in (7) to (10), wherein (7) is minimized while subject to (8) and (9).

f=Σᵢ₌₁^{N}Fᵢ(Pᵢ) (7)

where Fᵢ(Pᵢ)=A+BPᵢ+CPᵢ² (8)

P_{load}−Σᵢ₌₁^{N}Pᵢ=0 (9)

Pᵢ^{min}≤Pᵢ≤Pᵢ^{max} (10)

where for a unit i, Pᵢ is a generation base point, Fᵢ is an operating cost function with parameters A, B, and C, and Pᵢ^{min} and Pᵢ^{max} are power output limits related to a system load, P_{load}.

The above-outlined ED formulation may be considered a constrained optimization problem in a conventional power system. Classically, it may be implemented at pre-set intervals of 5-15 minutes. In order to solve the optimization problem, a gradient method via Lagrangian formulation may be employed. Further, as described in an embodiment of the present disclosure, a real-time ED Lagrangian formulation, as described in (11), may be evaluated, wherein a first term of L is an objective function, a second term represents a generation-load balance equality constraint, and a third term represents generation constraints for all generators.

L=Σᵢ₌₁^{N}Fᵢ(Pᵢ)+λ(P_{load}−Σᵢ₌₁^{N}Pᵢ)+Σᵢ₌₁^{N}βᵢ(Pᵢ−Pᵢ^{lim}) (11)

Moreover, λ may be the Lagrange multiplier associated with the equality constraint and βᵢ may be the Lagrange multiplier associated with each of the generation limits. An optimal solution may be determined by driving each of the partial derivatives of the Lagrangian formulation to zero, as described in (12).

$$[ \begin{matrix}\frac{\partial L}{\partial {P}_{i}} \\ \frac{\partial L}{\partial λ}\end{matrix} ] = [ \begin{matrix}\frac{d {F}_{i} ( {P}_{i} )}{d {P}_{i} } - λ + {β}_{i} \\ {P}_{load} - {\sum }_{i = 1}^{N} {P}_{i}\end{matrix} ] = 0 ∀ i ∈ N \qquad ( 12 )$$

Complementary slackness conditions (13) may be used to handle inequality constraints.

$${β}_{i} = \{ \begin{matrix}0 , if {P}_{i}^{min} < {P}_{i} < {P}_{i}^{max} \\ > 0 , if {P}_{i} = {P}_{i}^{min} or {P}_{i} = {P}_{i}^{max}\end{matrix} \qquad ( 13 )$$

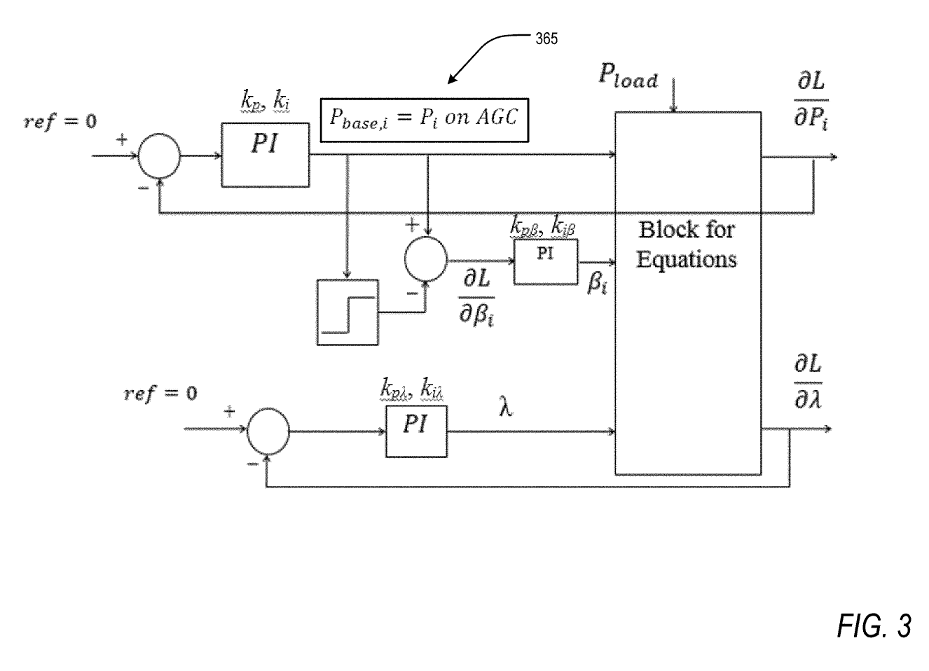

This optimization may be performed at discrete instants of time or, for example, once every 15 minutes. Once the optimization is performed and optimal powers, Pᵢ, are obtained, the generators' base points may be adjusted, accordingly. As such, the input base power for each generator on AGC is updated by setting P_{base, i}=Pᵢ 365, as indicated in FIG. 3.

To this end, the real-time ED described in (11) to (13) may be formulated as a feedback control problem, wherein the inputs, or desired outputs, of the control scheme are zero and the real outputs of the control scheme are the Lagrangian partial derivatives. At a high level, a multiple generator plant may be represented by the equations of the partial derivatives, and the controls, thereof, are Pᵢ, λ, and βᵢ. At steady-state, the system may operate at the optimal operating point where all partial derivatives are zero. If system load, considered a disturbance in this control scheme, deviates, the partial derivatives may deviate from zero, accordingly. This deviation may be detected by a proportional-integral (PI) controller at each generator, each of which will drive one of the local controls such that optimality is restored.

According to an embodiment, the above-described ED optimization may temporarily restore system optimality. While restoring system efficiency, it may be slower than a classical AGC control loop, and thus, may not be independently sufficient. As a result, according to an embodiment, the present disclosure describes integration of AGC and control-based ED.

### Integrated Economic Dispatch—Automatic Generation Control Scheme

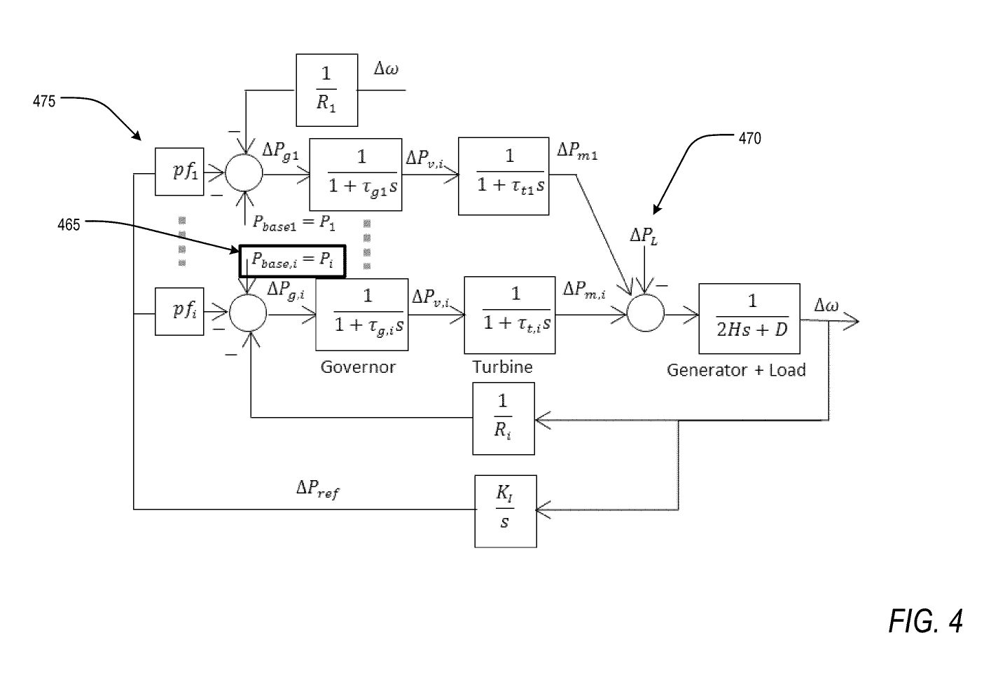

AGC may be incorporated into the control-based ED by directly feeding the generators' set-points from the control-based ED loop to the AGC loop, as shown in FIG. 4. That is, FIG. 4 is a schematic of an exemplary control scheme integrating ED and AGC schemes. For every generator, P_{base, i}, is set to be equal to Pᵢ 465, therefore becoming a control for the ED loop. Every generator may be modeled individually on the AGC loop by its governor and turbine, only. Further, in simplifying system load (generator and load) to a single value (ΔP_{L}) 470, instead of dis-aggregating system load into individual generators, the integrated approach of the present disclosure eliminates the need for participation factors and control gains specific to each generator. Moreover, the supplementary loop of the AGC model may be replaced by the control-based ED loop, described herein. In other words, in the proposed integrated ED-AGC scheme, pfᵢ 475 of the AGC loop may be set to zero.

### Non-Limiting Experimental Simulations and Results

The above-described classical approaches assume that ED is implemented once every 15 minutes. Therefore, if the system load changes after ED has been implemented and the generators' base points have been set, AGC must be used to adjust the generators' desired power outputs based on droop characteristics, supplementary control, and participation factors. According to an embodiment, however, the integrated control strategy of the present disclosure is able to continuously maintain an optimal solution, detecting and responding to fluctuations in load in real-time.

According to an exemplary embodiment, the integrated ED-AGC control scheme of the present disclosure may be implemented by a control device, via processing circuitry, configured to send and receive relevant data with a multi-generator system of generators.

Further, according to an exemplary embodiment, the integrated ED-AGC control scheme of the present disclosure may be evaluated on a six-bus, three-generator system, as described in “Power Generation, Operation, and Control”, by Wood A J, et al., and incorporated herein by reference in its entirety. Buses one to three may be generator buses while buses four to six may be load buses. Table 1 summarizes a selection of parameters key to generator performance and control. Further, Table 2 summarizes the parameters used for a classical AGC control scheme while Table 3 summarizes the PI controllers' parameters for the integrated ED-AGC control scheme of the present disclosure. The parameters of the PI controllers drive the generators' set-points, Pᵢ, and the Lagrange multipliers, λ and β. These parameters may be carefully tuned to obtain reasonable transient behavior in response to load changes. It can be appreciated that, in an exemplary embodiment of the integrated ED-AGC control scheme of the present disclosure, values of R shown in Table 2 may be used while the participation factors, Pf, may be set to zero.

In each of the below-described simulations, net loads are evaluated. To obtain the net load, renewable generation is defined as a negative load. At t=0, the net load at each of the three load buses is assumed to be 100 MW. This is assumed to be the base load for a classical approach. Hence, P_{base} for generators one to three may be set at 72.64, 118.69, and 108.66 MW, respectively.

TABLE 1
Generators’ Parameters

| Gen # | 1 | 2 | 3 |
|---|---|---|---|
| A | 213.1 | 200 | 240 |
| B | 11.669 | 10.333 | 10.833 |
| C | 0.00533 | 0.00889 | 0.00741 |
| P^{min} | 50 | 37.5 | 45 |
| P^{max} | 200 | 150 | 180 |
| τₜ | 0.2 | 0.2 | 0.2 |
| τ_{g} | 0.2 | 0.2 | 0.2 |
| R | 0.01 | 0.02 | 0.02 |
| Pf | 0.2 | 0.4 | 0.4 |

TABLE 2
Parameters for the Classical Approach

| Gen # | 1 | 2 | 3 |
|---|---|---|---|
| R | 0.01 | 0.02 | 0.02 |
| Pf | 0.2 | 0.4 | 0.4 |

TABLE 3
Controllers' Parameters for
the Integrated ED-AGC Control Scheme

| | Parameter | Value |
|---|---|---|
| PI controllers | kₚ | 250 |
| that drive Pi | kᵢ | 1500 |
| PI controller | k_{pλ} | 250 |
| that drives λ | k_{iλ} | 1500 |
| PI controller | k_{pβ} | 0.9 |
| that drives β | k_{iβ} | 0.06 |

### A. Test 1: Total Net Load of 300 MW

In Test 1, the net load at each of the three load buses may be set to 100 MW. The optimal loading levels of the three generators obtained via the integrated ED-AGC control scheme are: P1=72.64 MW, P2=118.69 MW, and P3=108.66 MW. The system's incremental cost (λ) is 12.44 $/MWh, and the total operating cost is 41450.0 $/hr. These results are in agreement with those obtained from a classical ED model, confirming the utility of the ED control scheme.

### B. Test 2: Responses to Step Increase in Net Load

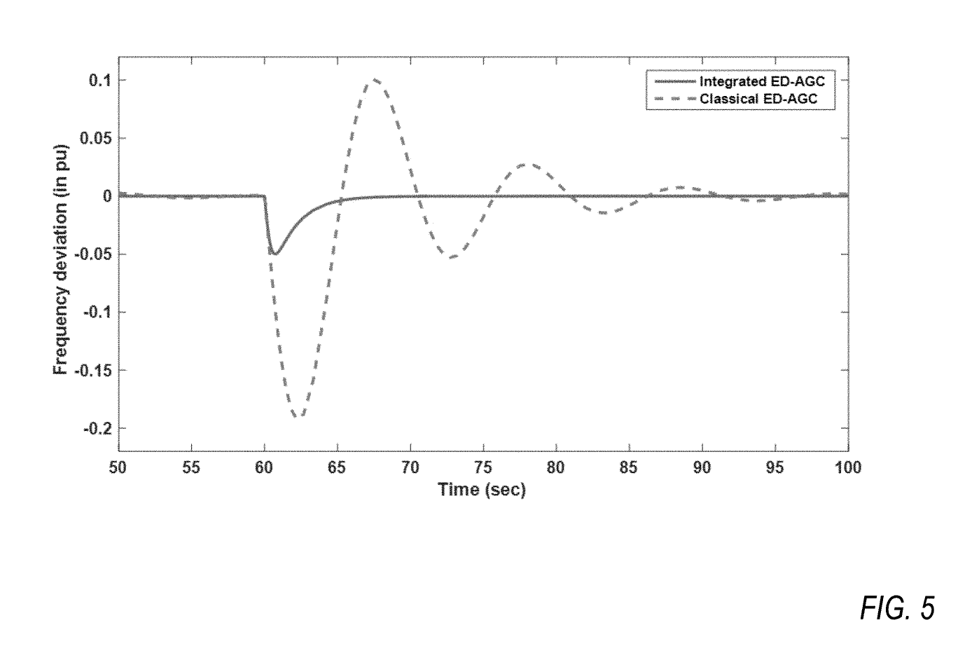

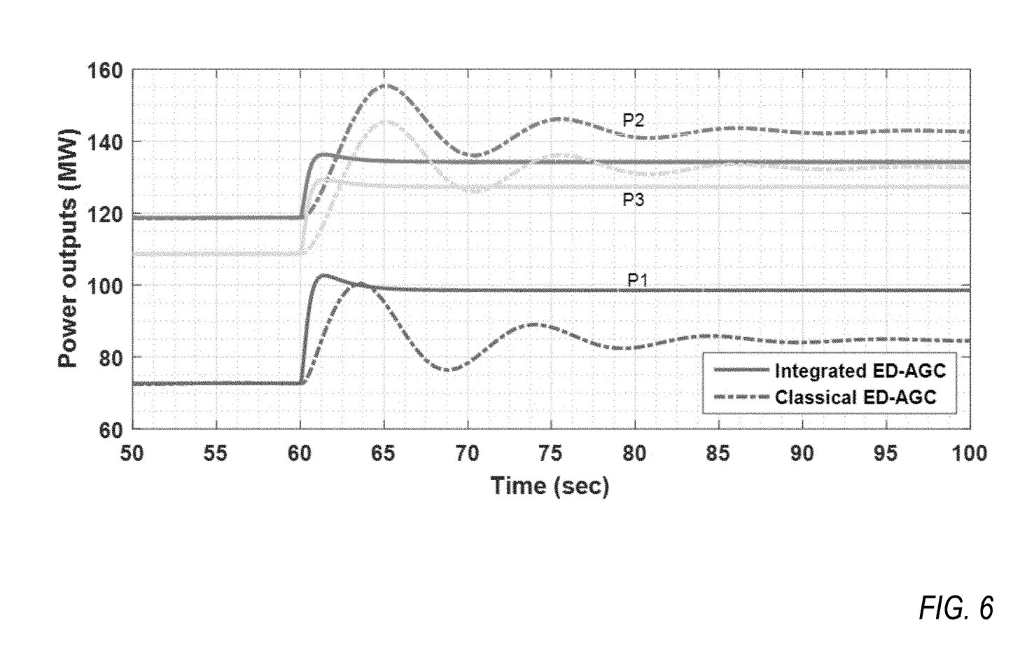

In Test 2, the net load at each of the three load buses may be set such that a step change from 100 MW to 120 MW is experienced at t=60 seconds. FIG. 5 and FIG. 6 illustrate the changes in the system's frequency and generators' outputs, respectively, due to the change in load. For comparison, the step response of the classical, independent ED-AGC control scheme is shown as a dashed line. According to an embodiment, it may be observed that the integrated ED-AGC control scheme of the present disclosure outperforms the classical, independent ED-AGC control scheme. Table 4 summarizes the power output values at steady state for each control scheme after the change in net load. It should be appreciated that the integrated ED-AGC control scheme efficiently adjusts generator power outputs with respect to optimal power output levels.

TABLE 4
Steady State Results for Test 2 at a Total Net Load of 360 MW

| | Classical | Integrated | Optimal Power |
|---|---|---|---|
| | ED-AGC | ED-AGC | Outputs |
| P1 (MW) | 84.63 | 98.52 | 98.52 |
| P2 (MW) | 142.70 | 134.21 | 134.21 |
| P3 (MW) | 132.67 | 127.27 | 127.27 |
| Total Cost ($/hr) | 4902.0 | 4900.2 | 4900.2 |

### C. Test 3: Responses to Random Changes in Net Load Due to Renewable Energy Variability

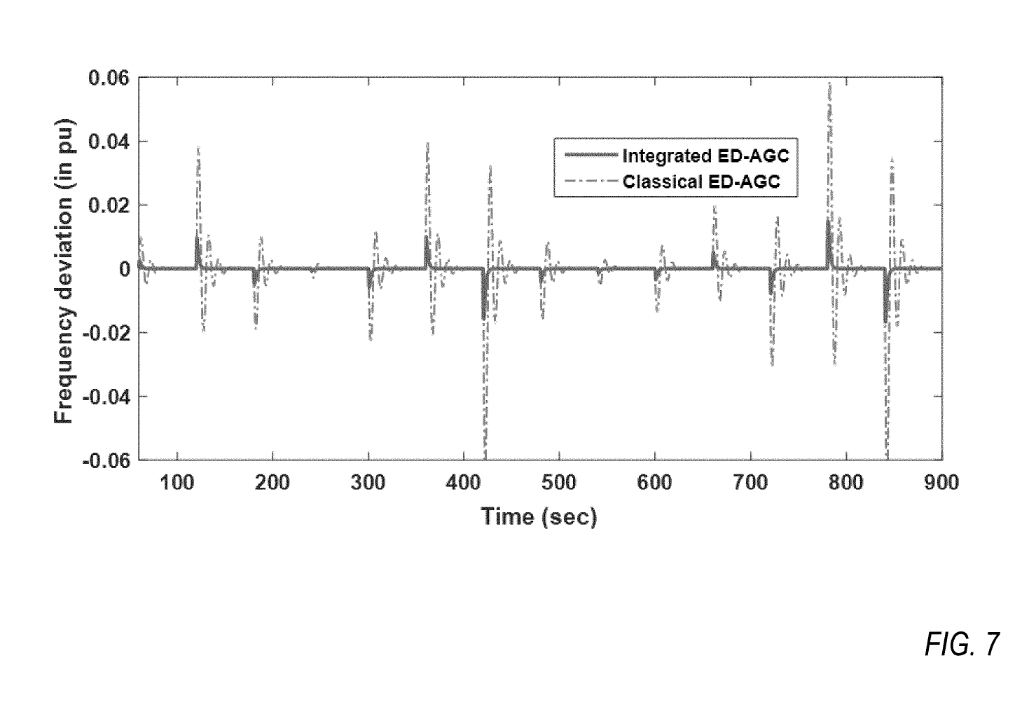

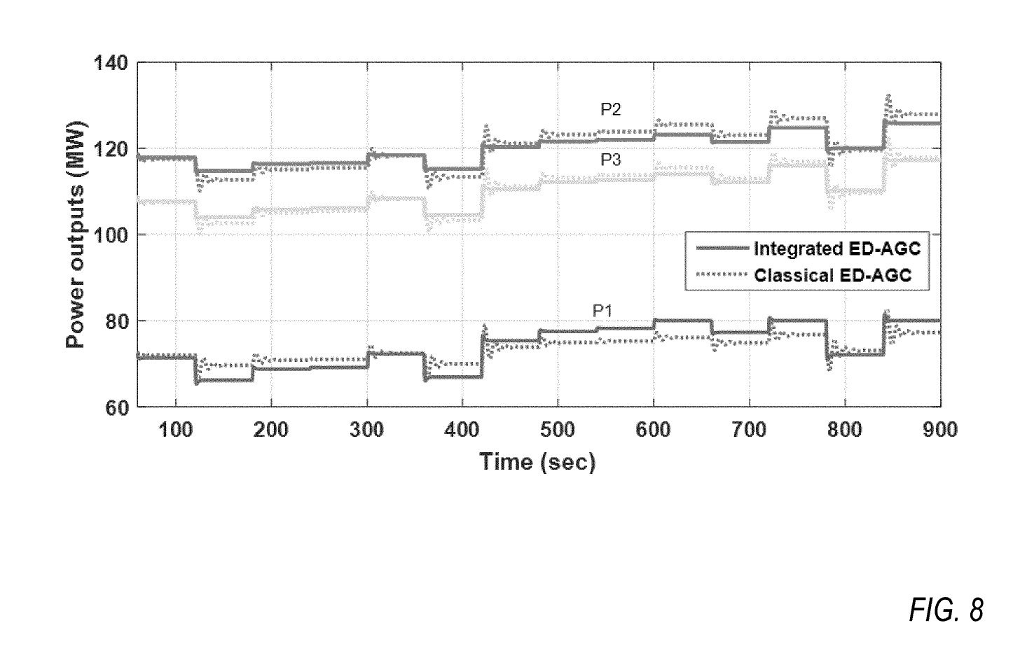

In Test 3, the net load at each of the three load buses is prescribed to randomly change. These random fluctuations are meant to simulate the behavior of a system with significant wind, or other renewable energy source, penetration. Also, in order to evaluate the ability of the integrated ED-AGC control scheme to operate within generator limits, reflecting real world constraints, the maximum power output of generator one may be reduced to 80 MW. FIG. 7 and FIG. 8 demonstrate the changes in the system's frequency and generators' power outputs in response to the change in load. FIG. 7 and FIG. 8, respectively, illustrate the ability of the integrated ED-AGC control scheme of the present disclosure to suppress frequency deviations and track the generators' optimal set points while observing operational limits, as exemplified above.

### Control Device

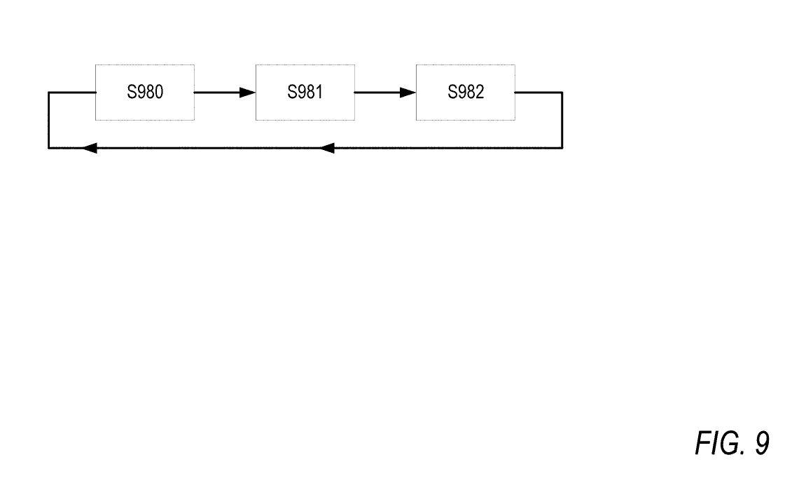

FIG. 9 is a flowchart describing an implementation of a control device having a processing circuitry configured to execute an integrated ED-AGC control scheme, according to an embodiment of the present disclosure. First, initial net load power data from the electric power system, reflecting both demand and generation, may be received S980. Then, based upon the received initial net load power data, one or more power generation set-points of one or more power generation units may be determined S981. These one or more power generation set-points, established according to the above-described ED loop of the integrated ED-AGC control scheme and transmitted to a corresponding at least one power generation unit, restore optimality to the one or more power generation units in context of electric power system load, or demand. Subsequently, according to the above described AGC loop of the integrated ED-AGC control scheme, the one or more power generation set-points of the one or more power generation units may be updated according to a measured frequency deviation of each of the one or more power generation units S982. Frequency deviations of each of the one or more power generation units may be based upon a difference between a nominal frequency of the electric power system and a frequency of a turbine of each of the one or more power generation units.

According to an embodiment, the above described process may be iterative and, following update of the one or more power generation set-points, the integrated ED-AGC control scheme again determines one or more power generation set-points S981 based upon a subsequently received net load power data of the electric power system S980.

According to an embodiment, updating the one or more power generation set-points may be based an error value of the measured frequency deviation. In an embodiment, the one or more power generation set-points are updated such that the error value of the measured frequency deviation is minimized.

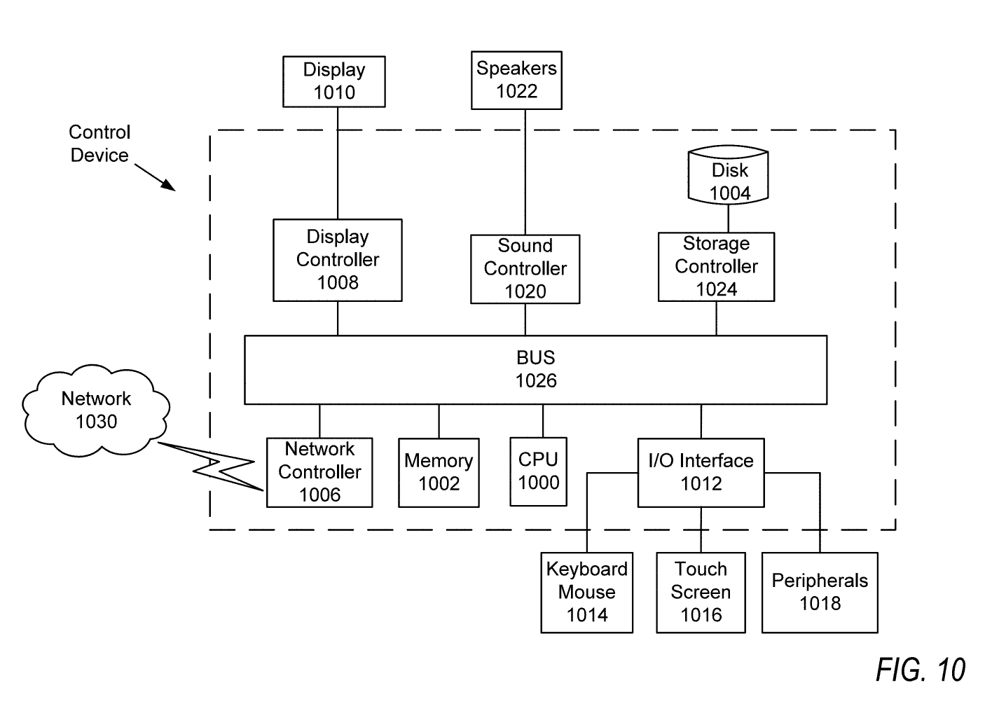

Next, a hardware description of the control device according to exemplary embodiments is described with reference to FIG. 10. In FIG. 10, the control device includes a CPU 1000 which performs the processes described above. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the control device communicates, such as a server or computer.

Further, the advancements disclosed herein may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the control device may be realized by various circuitry elements, known to those skilled in the art. For example, CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

The control device in FIG. 10 also includes a network controller 1006, such as an Intel Ethernet PRO network interface card from Intel Corporation of America, for interfacing with network 1030. As can be appreciated, the network 1030 can be a public network, such as the Internet, or a private network such as an LAN or WAN network, or any combination thereof and can also include PSTN or ISDN sub-networks. The network 1030 can also be wired, such as an Ethernet network, or can be wireless such as a cellular network including EDGE, 3G and 4G wireless cellular systems. The wireless network can also be WiFi, Bluetooth, or any other wireless form of communication that is known.

The control device further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the control device, such as Sound Blaster X-Fi Titanium from Creative, to interface with speakers/microphone 1022 thereby providing sounds and/or music. In an example, the sound controller 1020 interfaces with the speakers 1022 to provide an audible alert to a technician of an extraordinary frequency deviation.

The general purpose storage controller 1024 connects the storage medium disk 1004 with communication bus 1026, which may be an ISA, EISA, VESA, PCI, or similar, for interconnecting all of the components of the control device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method for regulating power generation, comprising:
receiving, via processing circuitry, initial net load power data from an electric power system;
determining, via the processing circuitry, one or more power generation set-points of one or more power generation units based upon the initial net load power data;
transmitting, via the processing circuitry, each of the one or more power generation set-points to a corresponding at least one power generation unit of the one or more power generation units;
measuring, via the processing circuitry, a frequency deviation of each of the one or more power generation units; and
updating, via the processing circuitry, the one or more power generation set-points of the one or more power generation units,
wherein updating the one or more power generation set-points of the one or more power generation units is based upon the measured frequency deviation of each of the one or more power generation units.

2. The method according to claim 1, wherein the measured frequency deviation of each of the one or more power generation units is based upon a difference between a nominal frequency of the electric power system and a frequency of a turbine of the each of the one or more power generation units.

3. The method according to claim 1, further comprising:
receiving, via the processing circuitry, subsequent net load power data from the electric power system; and
updating, via the processing circuitry, the one or more power generation set-points based upon the subsequent net load power data.

4. The method according to claim 3, wherein the updating further comprises determining, via the processing circuitry, a difference between the one or more power generation set-points and a subsequent load of the subsequent net load power data.

5. The method according to claim 2, further comprising:
calculating, via the processing circuitry, an error value of the measured frequency deviation; and
determining, via the processing circuitry, the updated one or more power generation set-points based upon the calculated error value.

6. The method according to claim 5, wherein determining the updated one or more power generation set-points minimizes the calculated error value.

7. The method according to claim 1, wherein the determined one or more power generation set-points of the one or more power generation units is based upon an electric power system equivalent net load power data.

8. A non-transitory computer-readable storage medium storing computer-readable instructions that, when executed by a computer having a processing circuitry, cause the computer to perform a method, the method comprising:
receiving initial net load power data from an electric power system;
determining one or more power generation set-points of one or more power generation units based upon the initial net load power data;
transmitting each of the one or more power generation set-points to a corresponding at least one power generation unit of the one or more power generation units;
measuring a frequency deviation of each of the one or more power generation units; and
updating the one or more power generation set-points of the one or more power generation units,
wherein updating the one or more power generation set-points of the one or more power generation units is based upon the measured frequency deviation of each of the one or more power generation units.

9. The method according to claim 8, wherein the measured frequency deviation of each of the one or more power generation units is based upon a difference between a nominal frequency of the electric power system and a frequency of a turbine of the each of the one or more power generation units.

10. The method according to claim 8, further comprising:
receiving subsequent net load power data from the electric power system; and
updating the one or more power generation set-points based upon the subsequent net load power data.

11. The method according to claim 10, wherein the updating further comprises determining a difference between the one or more power generation set-points and a subsequent load of the subsequent net load power data.

12. The method according to claim 9, further comprising:
calculating an error value of the measured frequency deviation; and
determining the updated one or more power generation set-points based upon the calculated error value.

13. The method according to claim 12, wherein determining the updated one or more power generation set-points minimizes the calculated error value.

14. The method according to claim 8, wherein the determined one or more power generation set-points of the one or more power generation units is based upon an electric power system equivalent net load power data.

15. A system for regulating power generation of an electric power system, comprising:
one or more power generation units; and
a control device having a processing circuitry configured to:
receive initial net load power data from the electric power system;
determine one or more power generation set-points of at least one of the one or more power generation units based upon the initial net load power data;
transmit each of the one or more power generation set-points to a corresponding at least one power generation unit of the one or more power generation units;
measure a frequency deviation of each of the one or more power generation units; and
update the one or more power generation set-points of the one or more power generation units,
wherein updating the one or more power generation set-points of the one or more power generation units is based upon the measured frequency deviation of each of the one or more power generation units.

16. The system according to claim 15, wherein the measured frequency deviation of each of the one or more power generation units is based upon a difference between a nominal frequency of the electric power system and a frequency of a turbine of the each of the one or more power generation units.

17. The system according to claim 15, wherein the processing circuitry is further configured to:
receive subsequent net load power data from the electric power system; and
update the one or more power generation set-points based upon the subsequent net load power data.

18. The system according to claim 17, wherein the updating is based upon a determination of a difference between the one or more power generation set-points and a subsequent load of the subsequent net load power data.

19. The system according to claim 16, wherein the processing circuitry is further configured to:
calculate an error value of the measured frequency deviation; and
determine the updated one or more power generation set-points based upon the calculated error value.

20. The system according to claim 15, wherein the determined one or more power generation set-points of the one or more power generation units is based upon an electric power system equivalent net load power data.
